(19) United States
(12) Patent Application Publication
(10) Pub. No.: US 2014/0316068 A1
(43) Pub. Date: Oct. 23, 2014

(54) BIMODAL TOUGHENING AGENTS FOR THERMOSETTABLE EPOXY RESIN COMPOSITIONS

(71) Applicants: George C. Jacob, Saginaw, MI (US); Yasmin N. Srivastava, Sugar Land, TX (US); Nikhil E. Verghese, Lake Jackson, TX (US); Theofanis Theofanous, Lake Jackson, TX (US); Ludovic Valette, Lake Jackson, TX (US); Ha Q. Pham, Lake Jackson, TX (US)

(72) Inventors: George C. Jacob, Saginaw, MI (US); Yasmin N. Srivastava, Sugar Land, TX (US); Nikhil E. Verghese, Lake Jackson, TX (US); Theofanis Theofanous, Lake Jackson, TX (US); Ludovic Valette, Lake Jackson, TX (US); Ha Q. Pham, Lake Jackson, TX (US)

(73) Assignee: DOW GLOBAL TECHNOLOGIES LLC, Midland, MI (US)

(21) Appl. No.: 14/356,729

(22) PCT Filed: Nov. 1, 2012
(86) PCT No.: PCT/US12/62937

§ 371 Date: May 7, 2014

Related U.S. Application Data
(60) Provisional application No. 61/557,070, filed on Nov. 8, 2011.

(51) Int. Cl. C08L 63/00; C08L 21/00

(52) U.S. Cl. CPC C08L 63/00; C08L 21/00
USPC 525/108; 525/227; 525/228; 525/232; 525/241

(57) ABSTRACT

A bimodal toughening agent comprising a) a first preformed coreshell toughening agent and b) a second preformed coreshell toughening agent wherein the second preformed coreshell toughening agent has a particle size of at least two times larger than that of the first preformed coreshell toughening agent, and the use of the bimodal toughening agent in a thermosettable epoxy resin composition, is disclosed.

### REFERENCE TO RELATED APPLICATIONS

The present application claims the benefit of U.S. Provisional Application No. 61/557,070, filed on Nov. 8, 2011.

### BACKGROUND OF THE INVENTION

### Field of the Invention

The present invention is related to epoxy resin compositions; and more specifically, to epoxy resin compositions with bimodal toughening agents. The epoxy resin compositions of the present invention are useful in various applications where toughness is required such as composites, coatings and adhesives.

### INTRODUCTION

Among all the thermosetting resins, epoxy resins are unique and have special chemical characteristics: no byproducts or volatiles are formed during curing reactions, so shrinkage is low; they can be cured over a wide range of temperatures; and the degree of cross-linking can be controlled. Because of these unique characteristics, elevated temperature service capability and adequate electrical properties, epoxy resins are widely used in structural adhesives, surface coatings, engineering composites, and electrical laminates. However, the major drawback of epoxy resins is that in the cured state they are brittle materials having fracture energies some two orders of magnitude lower than engineering thermoplastics and three orders lower than metals.

During the past decade, considerable efforts have been made to improve the toughness of epoxy thermosets. Many of the typical toughening agents, such as elastomers or thermoplastics, inorganic/hybrid particles have shown to do a good job of improving toughness. But very often this improvement has come at the expense of other desirable mechanical/thermal properties and/or ease of processibility of the uncured formulation.

Epoxy resins have been most successfully toughened by incorporating elastomeric filler as a distinct phase of microscopic particles. This can be achieved in two ways: 1) blending with functionalized liquid rubber that is miscible at the beginning but is ejected out of the continuous epoxy phase during crosslinking due to restricted solubility in the evolving continuous phase (often called reactive induced phase separation) and 2) by dispersing preformed elastomeric particles directly in the epoxy matrix. Although CTBN or ATBN type liquid rubbers are very efficient for improving the fracture properties of epoxy resins without sacrificing excessively the modulus and strength, these unsaturated elastomeric modifiers have some drawbacks. The main deficiency of these oligomers is the high level of unsaturation in their structure, which provides sites for degradation reactions in oxidative and high temperature environments. The presence of double bonds in the chains can cause oxidation reactions and/or further cross-linking with the loss of elastomeric properties and ductility of the precipitated particles. Secondly, there is some limitation in its use due to possibility of the presence of traces of free acrylonitrile, which is carcinogenic. Hence, considerable efforts have been made, in the last decade, to use preformed particles as modifiers to improve the toughness.

### SUMMARY OF THE INVENTION

In an embodiment of the present invention there is disclosed a bimodal toughening agent comprising, consisting of, or consisting essentially of (a) a first preformed coreshell toughening agent and (b) a second preformed coreshell toughening agent wherein the second preformed coreshell toughening agent has a particle size of at least two times larger than that of the first preformed coreshell toughening agent.

Hence, the present invention is directed to improving fracture toughness due to a synergy resulting from using a bimodal particle size distribution of preformed core shell type toughening agents.

### DETAILED DESCRIPTION OF THE INVENTION

In an embodiment, there is disclosed a bimodal toughening agent comprising, consisting of, or consisting essentially (a) a first preformed coreshell toughening agent and (b) a second preformed coreshell toughening agent wherein the second preformed coreshell toughening agent has a particle size of at least two times larger than that of the first preformed coreshell toughening agent.

Another embodiment of the present invention comprises a thermosettable resin composition comprising (i) at least one epoxy resin, (ii) at least one curing agent and (iii) the preformed toughening agent described above.

### Toughening Agent

One embodiment of the present invention comprises a preformed bimodal toughening agent comprising (a) at least a first coreshell toughening agent and (b) at least a second coreshell toughening agent. At least one of the first coreshell toughening agent and second coreshell toughening agent is elastomeric. In an embodiment, both the first coreshell toughening agent and second coreshell toughening agent are elastomeric.

An elastomer is a polymer having the elastic properties of natural rubber.

By “coreshell rubber particles” or “coreshell rubber” it is meant herein that particles comprise a shell containing a core which is softer than the shell.

By “preformed” it is meant herein that particles have a shape and properties at the point of being added to the formulation and do not form during the curing process.

### First Coreshell Toughening Agent

Examples of the shell include, but are not limited to any type of acrylates, such as, for example, polymethyl methacrylates, modified acrylates, and combinations thereof.

Examples of the core include but are not limited to polybutadiene, polystyrene, polybutylacrylates, and combinations thereof. In an embodiment, Paraloid™ coreshell particles are used.

Generally, the particle size of the first coreshell toughening agent may be from 5 to 600 nanometers, preferably from 10 to 400 nm, and more preferably from 50 to 200 nm To observe the synergistic effect of bimodality, the difference in size of the first and second coreshell toughening agents needs to be at least 100 nm.

In general, the preformed toughening agent may include from 1 weight percent (wt %) to 30 wt % of the first coreshell toughening agent. In other embodiments, the preformed toughening agent may include from 1 wt % to 20 wt % of the first coreshell toughening agent; and from 1 wt % to 10 wt % of the first coreshell toughening agent in other embodiments. Loadings below 1 wt % may not show significant improvement in fracture toughness and concentrations of toughening agents above 30 wt % may lower glass transition temperature and modulus, and may also lead to an increase in viscosity of the resin and negatively affect its process ability.

### Second Coreshell Toughening Agent

The preformed bimodal toughening agent also includes at least a second coreshell toughening agent. These can have cores and shells which are generally selected from the examples described above. Generally, the particle size of the second coreshell toughening agent may be in the range of from 100 nm to 5000 nm, preferably from 200 nm to 2000 nm, and more preferably from 300 nm to 1000 nm.

In general, the preformed toughening agent may include from 1 wt % to 30 wt % of the first coreshell toughening agent. In other embodiments, the preformed toughening agent may include from 1 wt % to 20 wt % of the first coreshell toughening agent; and from 1 wt % to 10 wt % of the first coreshell toughening agent in other embodiments.

In an embodiment, the second preformed coreshell toughening agent has a particle size of at least two times larger than that of the first preformed coreshell toughening agent. In another embodiment, the second preformed coreshell toughening agent has a particle size of at least three times larger than that of the first preformed coreshell toughening agent. While not wishing to be bound by theory, it is believed that by changing the distribution of particles from unimodal to bimodal, higher fracture toughness for epoxy resins can be achieved for the same amount of toughening agent. This allows for higher fracture toughness at lower cost but not at the expense of other key performance attributes like Tg and modulus. The factors that affect the fracture toughness of the modified epoxy such as morphology, particle size, composition and compatibility can be easily controlled by using preformed particles versus liquid rubber modified systems, where in it is difficult to control the morphology. Phase separation, in case of liquid rubber toughening depends upon the formulation, processing and curing conditions. Incomplete phase separation can result in a significant lowering of glass transition temperature (Tg). Moreover, the rubber phase that separates during cure is difficult to control and may result in uneven particle size. The differences in morphology and volume of the separated phase affect the mechanical performance of the product. These problems can be minimized by using preformed elastomeric particles.

### Epdxy Resin Composition Containing the Toughening Agent

Another embodiment of the present invention is a thermosettable resin composition comprising (i) at least one epoxy resin, (ii) at least one curing agent and (iii) the preformed toughening agent described above

The epoxy resin compositions of the present invention may be cured at room temperature or thermally cured with a wide range of curing agents. In addition, the toughening agent of the present invention may possibly be used in other thermosetting chemistries that are either photo cured or moisture cured.

### Epoxy Resin

The present invention composition includes at least one epoxy resin. Epoxy resins are those compounds containing at least one vicinal epoxy group. The epoxy resin may be saturated or unsaturated, aliphatic, cycloaliphatic, aromatic or heterocyclic and may be substituted. The epoxy resin may also be monomeric or polymeric.

The epoxy resins, used in embodiments disclosed herein for component (i) of the present invention, may vary and include conventional and commercially available epoxy resins, which may be used alone or in combinations of two or more. In choosing epoxy resins for compositions disclosed herein, consideration should not only be given to properties of the final product, but also to viscosity and other properties that may influence the processing of the resin composition.

Particularly suitable epoxy resins known to those skilled in the art are based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known to the skilled worker include reaction products of epichlorohydrin with o-cresol and, respectively, phenol novolacs. It is also possible to use a mixture of two or more epoxy resins.

The epoxy resins useful in the present invention for the preparation of the curable compositions, may be selected from commercially available products. For example, D.E.R.™ 331, D.E.R.™ 332, D.E.R.™ 334, D.E.R.™ 580, D.E.N.™ 431, D.E.N.™ 438, D.E.R.™ 736, or D.E.R.™ 732 available from The Dow Chemical Company may be used. As an illustration of the present invention, the epoxy resin component (a) may be a liquid epoxy resin, D.E.R.™ 383 (DGEBPA) having an epoxide equivalent weight of 175-185, a viscosity of 9.5 Pa-s and a density of 1.16 grams/cc. Other commercial epoxy resins that can be used for the epoxy resin component can be D.E.R.™ 330, D.E.R.™ 354, or D.E.R.™ 332.

Other suitable epoxy resins useful as component (a) are disclosed in, for example, U.S. Pat. Nos. 3,018,262,7,163,973, 6,887,574; 6,632,893, 6,242,083, 7,037,958, 6,572,971, 6,153,719, and 5,405,688, PCT Publication WO 2006/052727; U.S. Patent Application Publication Nos. 2006/0293172 and 2005/0171237.

In an embodiment, the epoxy resin useful in the composition of the present invention comprises any aromatic or aliphatic glycidyl ether or glycidyl amine or a cycloaliphatic epoxy resin. The composition of the present invention may include other resins such as diglycidyl ether of bisphenol A, diglycidyl ether of bisphenol F, cycloaliphatic epoxies, multifunctional epoxies, or resins with reactive and non-reactive diluents.

In general, the choice of the epoxy resin used in the present invention depends on the application. However, diglycidyl ether of bisphenol A (DGEBA) and derivatives thereof are particularly preferred. Other epoxy resins can be selected from but limited to the groups of: bisphenol F epoxy resins, novolac epoxy resins, glycidylamine based epoxy resins, alicyclic epoxy resins, linear aliphatic and cycloaliphatic epoxy resins, tetrabromobisphenol A epoxy resins, and combinations thereof.

In general, the composition may include from 1 wt % to 99 wt % of the epoxy resin based on the total weight of the composition. In other embodiments, the composition may include from 1 wt % to 50 wt % of the epoxy resin; from 1 wt % to 30 wt % of the epoxy resin in other embodiments; from 1 wt % to 20 wt % epoxy resin in other embodiments; and from 1 wt % to 10 wt % epoxy resin in yet other embodiments.

### Curing Agent

The curing agent is useful for the curable epoxy resin composition of the present invention, may comprise any conventional curing agent known in the art for curing epoxy resins. The curing agents, (also referred to as a hardener or cross-linking agent) useful in the thermosettable composition, may be selected, for example, from those curing agents well known in the art including, but are not limited to, anhydrides, carboxylic acids, amine compounds, phenolic compounds, polyols, or mixtures thereof.

Examples of curing agents useful in the present invention may include any of the co-reactive or catalytic curing materials known to be useful for curing epoxy resin based compositions. Such co-reactive curing agents include, but are not limited to polyamine, polyamide, polyaminoamide, dicyandiamide, polyphenol, polymeric thiols, polycarboxylic acids and anhydrides, and any combination thereof or the like. Suitable catalytic curing agents include tertiary amines, quaternary ammonium halides, Lewis acids such as boron trifluoride, and any combination thereof or the like. Other specific examples of co-reactive curing agent include but are not limited to phenol novolacs, bisphenol-A novolacs, phenol novolac of dicyclopentadiene, cresol novolac, diaminodiphenylsulfone, styrene-maleic acid anhydride (SMA) copolymers; and any combination thereof. Among the conventional co-reactive epoxy curing agents, amines and amino or amido containing resins and phenolics are preferred.

Preferably, the resin systems of the present invention can be cured using various standard curing agents including for example, amines, anhydrides and acids, and mixtures thereof.

Dicyandiamide may be one preferred embodiment of the curing agent useful in the present invention. Dicyandiamide has the advantage of providing delayed curing since dicyandiamide requires relatively high temperatures for activating its curing properties; and thus, dicyandiamide can be added to an epoxy resin and stored at room temperature (about 25° C.).

In general, the composition may include from 1 wt % to 80 wt % of curing agent based on the total weight of the composition. In other embodiments, the composition may include from 1 wt % to 60 wt % curing agent; from 1 wt % to 40 wt % curing agent in other embodiments; from 1 wt % to 30 wt % curing agent in other embodiments; and from 1 wt % to 20 wt % curing agent in yet other embodiments.

### Toughening Agent

The toughening agent, component (iii), useful for the curable epoxy resin composition of the present invention, comprises the toughening agent described in detail above.

In preparing the curable epoxy resin composition of the present invention, the composition may include generally from 1 wt % to 30 wt %, preferably from 1 wt % to 20 wt %, and more preferably from 1 wt % to 10 wt % of the toughening agent, based on the total weight of the composition. Loadings below 1 wt % may not show significant improvement in fracture toughness and concentration of TAs above 30 wt % may lower Tg and modulus, lead to increase in viscosity of the resin and negatively affect its processability.

### Optional Components

The epoxy resin composition of the present invention may include optional components or additives such as reactive or non reactive diluents, catalysts, and fillers.

### Diluents

In some embodiments, minor amounts of higher molecular weight, relatively non-volatile monoalcohols, polyols, and other epoxy- or isocyanato-reactive diluents may be used, if desired, to serve as plasticizers in the epoxy compositions disclosed herein. For example, isocyanates, isocyanurates, cyanate esters, allyl containing molecules or other ethylenically unsaturated compounds, and acrylates may be used in some embodiments. Exemplary non-reactive thermoplastic resins include polyphenylsulfones, polysulfones, polyethersolufones, polyvinylidene fluoride, polyetherimide, polypthalimide, polybenzimidiazole, acyrlics, phenoxy, and urethane. In other embodiments, compositions disclosed herein may also include adhesion promoters such as modified organosilanes (epoxidized, methacryl, amino), acytlacetonates, and sulfur containing molecules.

### Catalysts

Optionally, catalysts may be added to the curable compositions described above. Catalysts may include, but are not limited to, imidazole compounds including compounds having one imidazole ring per molecule, such as imidazole, 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 1-cyanoethyl-2-methylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, and the like; and compounds containing 2 or more imidazole rings per molecule which are obtained by dehydrating above-named hydroxymethyl-containing imidazole compounds such as 2-phenyl-4,5-dihydroxymethylimidazole, 2-phenyl-4-methyl-5-hydroxymethylimidazole and 2-phenyl-4-benzyl-5-hydroxy-methylimidazole; and condensing them with formaldehyde, e.g., 4,4′-methylene-bis-(2-ethyl-5-methylimidazole), and the like. In other embodiments, suitable catalysts may include amine catalysts such as N-alkylmorpholines, N-alkylalkanolamines, N,N-dialkylcyclohexylamines, and alkylamines where the alkyl groups are methyl, ethyl, propyl, butyl and isomeric forms thereof, and heterocyclic amines.

Mixtures of one or more of the above described catalysts may also be used.

### Other Optional Components

Curable compositions disclosed herein may optionally include conventional additives and fillers. Additives and fillers may include, for example, silica, glass, talc, metal powders, titanium dioxide, wetting agents, pigments, coloring agents, mold release agents, coupling agents, ion scavengers, UV stabilizers, flexibilizing agents, and tackifying agents. Additives and fillers may also include fumed silica, aggregates such as glass beads, polytetrafluoroethylene, polyol resins, polyester resins, phenolic resins, graphite, molybdenum disulfide, abrasive pigments, viscosity reducing agents, boron nitride, mica, nucleating agents, and stabilizers, among others. Fillers may also include particulate fillers and may include, for example, alumina trihydrate, aluminum oxide, aluminum hydroxide oxide, metal oxides, and nanofillers such as nano tubes).

In general, the composition may include from 0 wt % to 60 wt % of the optional additives. In other embodiments, the composition may include from 1 wt % to 30 wt % optional additives; from 1 wt % to 20 wt % optional additives in other embodiments, and from 1 wt % to 10 wt % optional additives in yet other embodiments.

### Process for Preparing the Compositions

The compositions of the present invention are generally prepared by admixing the components. The components can be admixed together in any combination or subcombination.

### End-Use Applications

End use applications include but are not limited to, are coatings, castings, composites, printed circuit boards, and adhesives.

### EXAMPLES

### Experimental Methods

### Fracture Toughness

To determine the Mode I fracture toughness of polymer, ASTM 5045 standard was followed. A compact tension specimen was used. All the plaques were cut using a water-jet cutting machine. A starter crack was carefully created by gently tapping a razor blade cooled with dry ice. The crack tip should be sharp to achieve the singularity of stress field. An electromechanical testing machine was used for all the testing with a load frame of 1000 N. The crosshead speed of 5 mm/min was used for all specimens. Load and displacement were recorded during the test using a computer controlled data acquisition system. Five to six samples were tested for each sample plaques.

### DMTA (Dynamic Mechanical Thermal Analysis)

Glass transition temperature was determined by dynamic mechanical thermal analyses were run in torsion mode using a TA instruments ARES rheometer fitted with a rectangular specimen fixture based on ASTM D4065. A frequency of 1 Hz was used for the test and each test spanned a temperature range of 25 to 180° C. at a heating rate of 10° C./min

### Optical Microscopy

Samples were initially cut from the cured plaques with a diamond saw and the obtained pieces were polished down to a measurable size. A region of interest was trimmed with fresh razor blades and optical sections approximately 3 microns thick were collected at −70° C. using a diamond knife on a Leica UCT microtome equipped with an FCS cryo-sectioning chamber. The sections were transferred to a microscope slide containing a drop of Dow Corning E200 silicon oil and covered with a cover glass. Transmitted brightfield light under differential interference contrast illumination mode was used to view the optical sections using a Carl Zeiss Axiolmager Zlm compound microscope and images were acquired with the aid of a HR digital camera.

### Scanning Electron Microscopy (SEM)

The block face of the polished epoxy plaque was post-stained with a 0.5% ruthenium tetra-oxide (RuO4) stock solution for 30 minutes and later mounted on SEM sample stub. The block face was coated with iridium for 25 seconds using an “Emitech K575X” plasma coater in order to render the specimen conductive. An “FEI Nova 600” scanning electron microscope was operated at 10 kV with a spot size of 4 and at a working distance between 4-5mm to examine the polished block surface.

### Toughening Agents

### Core—Shell Rubber (CSR):

Kumoho (0.6 micron), PC GRC (0.1 micron) core shell particles were used as toughening agents. GRC310 was the bimodal toughening agent used as the control.

Formulation and Plaque fabrication

The epoxy resin used in this study was windmill grade Airstone™ 780E, which is a mixture of Dow Epoxy Resin DER™ 383 and reactive diluent BDDGE (butane diol diglycidyl ether). The hardener used for this system was Airstone™ 785, which is a combination of three amines as shown in Part B of

Table 1 below.

TABLE 1
Composition of epoxy resin Airstone 780 E and amine hardener

| | Actual Wts (gms) | |
|---|---|---|
| PART A | | |
| Airstone ™ 780E | 251.9 | 251 |
| PART B | | |
| Jeffamine D230 | 50 | 50 |
| Vestamin IPD | 22.6 | 22.5 |
| DOW D.E.H. 52 | 5.5 | 5.5 |
| Total grams | 330 | 329 |
| TOTAL | 78.1 | 78 |

Plaque fabrication techniques for the epoxy resin with and without toughening agents are described below.

### Control

Part A (Airstone™ 780E) was weighed into a 26 oz. plastic container. As per the formulation, the required amounts of Part B components was added to Part A and mixed at 2000 rpm in a homo mixer at ambient temperature until it was homogenized. The plastic container without cap was placed in a vacuum oven at ambient and de-gassed by closing vent to create a seal. The vacuum was released by opening the vent whenever foam was observed in the sample. This process was repeated until formation of foams or bubbles stops. The mixture prepared was poured into a preassembled fixture and cured for 7 hours at 70° C. and allowed to cool down in the oven.

### Toughening Agent (TA) Modified Formulation

The process of fabricating plaques of control with TAs was very similar to the process of making the base epoxy resin except Part A and TAs were blended using the drill press at 2000 rpm and heated to help disperse the TAs. Approximately 8 hours was needed to mix the TAs in Part A.

### Example 1 and Comparative Examples A-C

TABLE 2

| | | | | Example 1 (Bimodal) |
|---|---|---|---|---|
| | | Comparative Example B | | Epoxy + 2.5 wt % PC |
| | | (Unimodal) Epoxy + | Comparative Example C | GRC (100 nm) + |
| | Comparative Example A | 5 wt % Kuhmo | (Unimodal Epoxy + | 2.5 wt % Kuhmo |
| Sample | (Control - Neat Epoxy) | Coreshell Rubber (600 nm) | 5 wt % PC GRC (100 nm) | Coreshell Rubber (600 nm) |
| DMTA - Modulus at | 1.05 | 1.29 | 1.04 | 1.14 |
| 35° C. (GPa) | | | | |
| DMTA - Final Tg for | 102.00 | 77.00 | 99.00 | 98.00 |
| tan delta peak (° C.) | | | | |
| K1c (MPa m^{0.5}) | 1.1 (standard | 2.37 to 2.39 | 2.49 to 2.52 | 3.31 to 3.52 |
| | deviation = 0.14) | | | |

TABLE 3
Summary Of Measurements for Bimodal and Unimodal systems. The
spatial distributions are characterized in terms of surface-to-
surface near-neighbor distances as well as the diameters of largest-
inscribed circles for open areas between particles.

| | PCGRC | Kumho | GRC310 | PCGRC/Kumho |
|---|---|---|---|---|
| TAs | Unimodal | Unimodal | Bimodal | Bimodal |
| vol % | 19.23% | 7.07% | 6.46% | 3.09% |
| MeanDiam | 0.147 | 0.432 | 0.292 | 0.159 |
| StDevDiam | 0.076 | 0.251 | 0.265 | 0.113 |

Near Neighbors (EDM saddle points) in microns.

| | PCGRC | Kumho | | PCGRC/ |
|---|---|---|---|---|
| TAs | Unimodal | Unimodal | GRC310Bimodal | Kumho |
| Mean | 0.182 | 1.349 | 0.853 | 0.876 |
| StdDev | 0.113 | 0.973 | 0.952 | 0.563 |
| RSD | 62.3% | 72.1% | 111.6% | 64.3% |
| Q spread | 0.96 | 0.84 | 0.36 | 0.93 |

OpenAreas (largest inscribed circle diameters) in microns.

| | PC_GRC_Uni- | Kumho | GRC310Bi- | PC_GRC/ |
|---|---|---|---|---|
| TAs | modal | Unimodal | modal | Kumho |
| Mean | 0.282 | 1.861 | 1.378 | 1.258 |
| StdDev | 0.103 | 0.911 | 1.078 | 0.547 |
| RSD | 36.7% | 49.0% | 78.3% | 43.4% |
| Qspread | 1.79 | 1.51 | 0.82 | 1.54 |

TABLE 4
Comparison Of Measurements for Comparative Bimodal
(GRC 310) and our Bimodal (PC GRC/Kumho) system.

| TAs | PC_GRC/Kumho | GRC310_Bimodal |
|---|---|---|
| Mean | 0.876 | 0.853 |
| StdDev | 0.563 | 0.952 |
| RSD | 64.3% | 111.6% |
| Qspread | 0.93 | 0.36 |
| Mean | 1.258 | 1.378 |
| StdDev | 0.547 | 1.078 |
| RSD | 43.4% | 78.3% |
| Qspread | 1.54 | 0.82 |

The near-neighbor distances are reported in the middle part of Table 2. Here the mean and standard deviations of the mean are presented, but the relative standard deviation (RSD) is also given:

RSD=100%×standard deviation/mean

This is a typical way to normalize the spreading characteristic of a population to the inherent magnitude of the population.

An additional characteristic was added based on quartile measurements: Q spread.

The intention is to characterize the spread of data around the median value in a way that higher values represented narrower distribution—that is, a sharper peak in the distribution. This is similar to the expression for the “Q factor” of a tuned electronic circuit. The quartile values in the distribution are determined:

1st quartile is the value for which 25% of the values are lower and 75% are higher
2nd quartile is the value for which 50% are lower and 50% are higher (typically know as the median)
3rd quartile is the value for which 75% are higher and 25% are lower.

The Q spread value is the ratio of the 2nd quartile value (median) to the difference between the 1st and 3rd quartiles. As the spread of the distribution narrows, the Q spread will go up. This number should be similar to the inverse of the relative standard deviation, but is not tied to the statistical assumption of a normal distribution. The formalism of the Q spread is inherently unstable if the breadth of the population drops to zero, but will otherwise show the breadth of the distribution with larger values indicating a narrower distribution.

The reported PCGRC/Kumho_bimodal system has a more uniform spatial distribution of particles than the reference GRC310 Epoxy bimodal system. This conclusion is based on looking at the RSD and Q spread values and is verified by comparing the conclusions with the appearances of the images. The spatial distributions are characterized in terms of surface-to-surface near-neighbor distances as well as the diameters of largest-inscribed circles for open areas between particles. The RSD of the reported PCGRC/Kumho bimodal system is much lower, 64.3% compared to the reference GRC 310system of 111.6%. The Q spread values are an alternate attempt to describe the breadth of the histograms. They are the ratio of the 50th quartile (median) value to the difference between the 75th quartile and the 25th quartile. A higher Q spread value indicates a sharper histogram peak. As seen in the table, PCGRC/Kumho bimodal system has a much higher Q spread of 0.93 compared to the reference GRC 310 system Q spread of 0.36.

In an embodiment, the fracture toughness as determined by ASTM D5045 is in the range of from 0.5 MPa to 5 MPa. In an embodiment, the modulus as determined by DMTA is in the range of from 1 to 4 GPa and wherein the glass transition temperature as determined by DMTA is in the range of from 50° C. to 95° C. In an embodiment, the Q spread value is greater than 0.4.

What is claimed is:

1. A bimodal toughening agent comprising:
a) a first preformed coreshell toughening agent and
b) a second preformed coreshell toughening agent;
wherein the second preformed coreshell toughening agent has a particle size of at least two times larger than that of the first preformed coreshell toughening agent.

2. The bimodal toughening agent of claim 1, wherein both said first preformed coreshell toughening agent and said second coreshell toughening agent are etastomeric.

3. The bimodal toughening agent of claim 1, wherein said first preformed coreshell toughening agent and said second preformed coreshell toughening agent comprise, independently of one another, a shell selected from the group consisting of polymethyl methacrylates, modified acrylates, and combinations thereof and a core selected from the group consisting of polybutadiene, polystyrene, polybutylacrylates, and combinations thereof.

4. The bimodal toughening agent of claim 1, wherein the first preformed coreshell toughening agent is present in an amount in the range of from 0.1 weight percent to 15 weight percent based on the total weight of the bimodal toughening agent and wherein the second preformed coreshell toughening agent is present in an amount in the range of from 0.1 weight percent to 15 based on the total weight of the bimodal toughening agent.

5. The bimodal toughening agent of claim 1, wherein the particle size of the first preformed coreshell toughening agent is in the range of from 5 nm to 300 nm and the particle size of the second preformed coreshell toughening agent is in the range of from 400 nm to 1000 nm.

6. A thermosettable epoxy resin composition comprising:
(a) an epoxy resin;
(b) a curing agent; and
(c) a bimodal toughening agent; wherein the bimodal toughening agent comprises
i) a first preformed coreshell toughening agent, and
ii) a second preformed coreshell toughening agent;
wherein the second preformed coreshell toughening agent has a particle size of at least two times larger than that of the first preformed coreshell toughening agent.

7. The thermosettable epoxy resin composition of claim 6, wherein said first preformed coreshell toughening agent and said second preformed coreshell toughening agent comprise, independently of one another, a shell selected from the group consisting of polymethyl methacrylates, modified acrylates, and combinations thereof and a core selected from the group consisting of polybutadiene, polystyrene, polybutylacrylates, and combinations thereof.

8. The thermosettable epoxy resin composition of claim 6, wherein the first preformed coreshell toughening agent is present in an amount in the range of from 0.1 weight percent to 15 weight percent based on the total weight of the bimodal toughening agent and wherein the second preformed coreshell toughening agent is present in an amount in the range of from 0.1 weight percent to 15 based on the total weight of the bimodal toughening agent.

9. The thermosettable epoxy resin composition of claim 6, wherein the concentration of the epoxy resin comprises from 40 weight percent to 99 weight percent, the concentration of the curing agent comprises from 1 weight percent to 60 weight percent, and the concentration of the toughening agent, comprises from 1 weight percent to 30 weight percent.

10. The thermosettable epoxy resin composition of claim 6 further comprising:
(d) at least one catalyst.

11. The thermosettable epoxy resin composition of claim 10, wherein the catalyst is selected from the group consisting of imidazoles and amines.

12. The thermosettable epoxy resin composition of claim 10, wherein the concentration of the catalyst comprises from 0.1 weight percent to 5 weight percent.

13. A process for preparing a thermosettable epoxy resin composition comprising:
admixing
(a) at least one thermosetting resin;
(b) at least one curing agent and
(c) at least one bimodal toughening agent wherein the bimodal toughening agent comprises a first preformed coreshell toughening agent, and a second preformed coreshell toughening agent and wherein the second preformed coreshell toughening agent has a particle size of at least two times larger than that of the first preformed coreshell toughening agent.

14. A product prepared by curing the composition of claim 12.
